(19) United States
(12) Patent Application Publication
(10) Pub. No.: US 2011/0134785 A1
(43) Pub. Date: Jun. 9, 2011

(54) SIGNAL GAIN CONTROL METHOD, SYSTEM, MEDIA GATEWAY AND MEDIA GATEWAY CONTROLLER

(76) Inventor: Yangbo Lin, Shenzhen (CN)

(21) Appl. No.: 13/026,934

(22) Filed: Feb. 14, 2011

Related U.S. Application Data
(63) Continuation of application No. PCT/CN2009/073169, filed on Aug. 10, 2009.

(30) Foreign Application Priority Data
Aug. 14, 2008 (CN) 200810118364.4
Aug. 14, 2008 (CN) 200810142465.5
Jun. 30, 2009 (CN) PCT/CN2009/072535

(51) Int. Cl. H04L 27/08; H04W 24/00

(52) U.S. Cl. 370/252; 370/328

(57) ABSTRACT

A signal gain control method, a system, a Media Gateway (MG), and a Media Gateway Controller (MGC) are disclosed. The method includes: an MG receives control information from an MGC, where the control information is about adjusting gain of a signal by setting the gain to a specific value directly or by increasing a value of the current gain; and the MG adjusts the gain of the signal according to the control information. Through an extended (media) gateway control protocol, the MGC delivers control information to the MG, thus implementing gain adjustment.

### CROSS-REFERENCE TO RELATED APPLICATIONS

This application is a continuation of International Application No. PCT/CN2009/073169, filed on Aug. 10, 2009, which claims priority to Chinese Patent Application No. 200810142465.5, filed on Aug. 14, 2008, both of which are hereby incorporated by reference in their entireties

### FIELD OF THE INVENTION

The present invention relates to mobile communication technologies, and in particular, to a gain control technology in a (media) gateway control protocol.

### BACKGROUND OF THE INVENTION

As shown in FIG. 1, a Media Gateway Controller (MGC) and a Media Gateway (MG) are two key components of a packet-switched network in an architecture where the service is separated from the bearer. The MGC is responsible for the service control function, and the MG is responsible for the media bearing function. In this way, the service control plane is separated from the media bearer plane, network resources are shared sufficiently, device upgrade and service extension are simplified, and the costs of development and maintenance are slashed.

The (media) gateway control protocol is a main protocol for communication between the MG and the MGC. Currently, two commonly used gateway control protocols are H.248/MeGaCo and Media Gateway Control Protocol (MGCP). The H.248/MeGaCo is an evolved product of the MGCP. MGCP version 1 was developed by Internet Engineering Task Force (IETF) in October 1999 and amended on January 2003; H.248/MeGaCo version 1 was developed by International Telecommunications Union (ITU) and IETF jointly in November 2000 and amended in June 2003; H.248 version 2 was developed by ITU in May 2002 and amended in March 2004; and H.248 version 3 was developed by ITU in September 2005 and amended in 2008.

As defined in H.248, signals are used by the MGC for instructing the MG to perform a certain resource operation such as playing voice. Signals are applied on a termination level or a stream level. When a signal is applied on a termination, it indicates that the signal is applicable to all streams on the termination simultaneously. A signal list may be used to represent a series of operations to be performed sequentially, and intervals may exist between the operations. The MGC delivers a signal descriptor that carries signals and/or a signal list to the MG The signals and/or signal lists in the signal descriptor delivered at a time are applied synchronously.

Signal application may be based on a certain gain. In practice, the gain needs to be adjusted. However, the prior art provides no mechanism of adjusting gain, and the MG is unable to adjust gain.

### SUMMARY OF THE INVENTION

The embodiments of the present invention provide a method for adjusting gain through an extended (media) gateway control protocol, a system, an MG, and an MGC to adjust gain of the MG.

A signal gain control method includes:

by an MG, receiving control information from an MGC, where the control information is about adjusting gain of a signal by setting the gain to a specific value directly or by changing the current value with an increment; and

adjusting the gain of the signal according to the control information.

An MG includes:

a receiving unit, configured to receive control information from an MGC, where the control information is about adjusting gain of a signal by setting the gain to a specific value directly or by changing the current value with an increment; and

an adjusting unit, configured to adjust the gain of the signal according to the control information.

A communication system includes:

an MGC, configured to send control information to an MG for adjusting gain of a signal by setting the gain to a specific value directly or by changing the current value with an increment; and

an MG configured to receive the control information and adjust the gain of the signal according to the control information.

An MGC includes:

a sending module, configured to send control information to an MG for adjusting gain of a signal by setting the gain to a specific value directly or by changing the current value with an increment.

The technical solution above reveals that: Through an extended (media) gateway control protocol, the MG receives control information from an MGC, where the control information is about adjusting gain of a signal by setting the gain to a specific value directly or by changing the current value with an increment; the MG adjusts the gain of the signal according to the control information. In this way, the MG can adjust the gain of the signal by setting the gain value directly or increasing the value of the current gain.

### BRIEF DESCRIPTION OF THE DRAWINGS

FIG. 1 shows a networking diagram of an MG and an MGC applied according to an embodiment of the present invention;

FIG. 2 is a flowchart of a gain adjustment method according to an embodiment of the present invention; and

FIG. 3 shows a system structure according to an embodiment of the present invention.

### DETAILED DESCRIPTION OF THE EMBODIMENTS

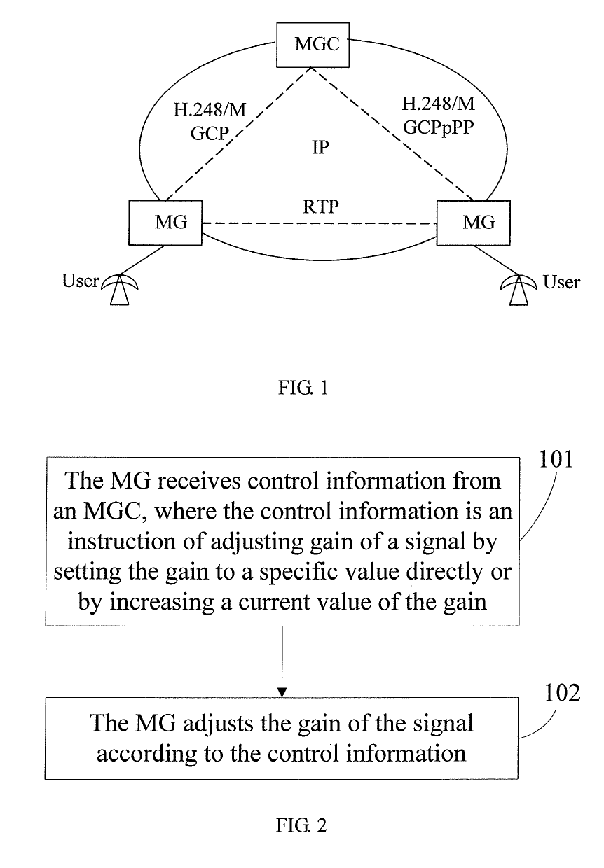

FIG. 1 shows a networking diagram of an MG and an MGC applied in an architecture where the service is separated from the bearer in an embodiment of the present invention.

The (media) gateway control protocol is a main protocol for communication between the MG and the MGC. Currently, two commonly used gateway control protocols are H.248/MeGaCo and Media Gateway Control Protocol (MGCP). The H.248/MeGaCo is evolved from the MGCP.

Taking H.248 as an example, various resources on the MG are abstractly expressed as terminations. Terminations are categorized into physical termination and ephemeral termination. A physical termination represents a physical entity of semi-permanent existence, for example, Time Division Multiplex (TDM) timeslots; and an ephemeral termination represents a public resource requested for temporary use and released after the use, for example, Real-Time Transport Protocol (RTP) streams. A special termination called “root termination” represents the entirety of the MG. Correlations between terminations are abstractly expressed as Context. A context may includes multiple terminations. Therefore, relations between terminations are expressed by a topology. A termination not correlated with any other termination is included in a special context called “null”.

Based on the foregoing abstract connection model, the interactions between the service and the bearer are equivalent to operations oriented to the termination and context. Such operations are performed through command requests and replies exchanged between the MGC and the MG. The types of commands include: Add, Modify, Subtract, Move, AuditValue, AuditCapabilities, Notify, and ServiceChange. Command parameters, also known as descriptors, are categorized into property, signal, event, and statistic. The parameters correlated to a service aggregate into a package logically.

The control exercised by the MGC onto the MG may be intended for a termination or streams on the termination. A TerminationState descriptor describes the features not specific to streams on the termination, for example, ServiceState, and EventBufferControl. A Media descriptor describes the features specific to streams on a termination. A Media descriptor may include several Stream descriptors. Each Stream descriptor is intended for a single stream, and includes a LocalControl descriptor, a Local descriptor, and a Remote descriptor. A LocalControl descriptor includes stream-related control information, for example, Mode, ReserveGroup, and ReserveValue. The Local descriptor describes the features of the streams received locally, and the Remote descriptor describes the features of the streams received remotely, for example, address, port, and codec algorithm, which are expressed through Session Description Protocol (SDP).

FIG. 2 shows a gain adjustment method in an embodiment of the present invention. The method includes the following steps:

101. The MG receives control information from an MGC, where the control information is about adjusting gain of a signal by setting the gain to a specific value directly or by changing the current value with an increment.

102. The MG adjusts the gain of the signal according to the control information.

### EMBODIMENT 1

Through an extended (media) gateway control protocol, a parameter is added for a specific signal (such as Play, PlayCollect, or PlayRecord). The parameter indicates adjustment of the gain of the signal, and is named as gain adjustment parameter. When the MGC needs to instruct the MG to adjust the gain of a specific signal such as Play signal, namely, when the MGC needs to instruct the MG to adjust the gain of the Play signal, the MGC delivers the Play signal and its gain adjustment parameter to the MG. The MG adjusts the gain of the Play signal on the MG according to the Play signal and its gain adjustment parameter. The gain adjustment parameter is a gain delta parameter or absolute gain parameter, as detailed below:

Gain delta (gd) parameter: The value of the gd parameter is an increment by which the target gain increases relative to the current gain of the signal namely, increment added to the value of the current gain. This parameter is an integer, measured in decibel or percent.

The value of this parameter bears the following meanings: A positive value of this parameter refers to decibels or percentage by which the target gain increases relative to the current gain; a negative value of this parameter refers to a decibels or percentage by which the target gain is lower than the current gain; and “0” means the target gain is the same as the current gain. The default value is “0”.

For example, the current gain is 200 decibels. If gd is 50 decibels or 25%, the target gain is 250 decibels; if gd is −50 decibels or -25%, the target gain is 150 decibels; if gd is 0 decibel or 0%, the target gain is still 200 decibels.

Absolute gain (ag) parameter: The value of the ag parameter is an absolute value to which the signal gain will be adjusted. That is, the target gain is set directly. This parameter is an integer, measured in decibels.

For example, if ag is 250, the target gain is 250 decibels; if ag is 100 decibels, the target gain is 100 decibels.

### EMBODIMENT 2

Through an extended (media) gateway control protocol, a signal is added to indicate adjustment of the gain of a specific signal. The signal is named as Gain Adjustment Information (“gai”). This signal includes at least one of the following parameters:

adjustment object: an adjustment object may be a signal identifier (“si”), a Signal List Identifier (“sli”), and a Media Resource Identifier (“mri”), which are of the string type; and

adjustment information, which may be indicated by a parameter named as gain adjustment parameter, which is either of the following parameters:

(1) Gain delta (gd) parameter: The value of the gd parameter is an increment between the current gain to the target gain of the signal, namely, increment added to the value of the current gain. This parameter is an integer, measured in decibel or percent.

The value of this parameter bears the following meanings: A positive value of this parameter refers to decibels or percentage by which the target gain increases relative to the current gain; a negative value of this parameter refers to a decibels or percentage by which the target gain is lower than the current gain; and “0” means the target gain is the same as the current gain. The default value is “0”.

(2) Absolute gain (ag) parameter: The value of the ag parameter is an absolute value to which the signal gain will be adjusted. That is, the target gain is set directly. This parameter is an integer, measured in decibel.

When the MGC needs to instruct the MG to adjust the gain of a specific signal, a list of signals, or a media resource, the MGC may deliver the foregoing gai signal to the MG, and set parameters such as si, sli, and/or mri of the signal as the corresponding signal identifier, signal list identifier, or media resource identifier; and set the gd parameter of the signal as an increment between the current gain and the target gain, or set the ag parameter of the signal as an absolute value of the target gain. After obtaining the signal and its parameters, the MG applies the adjusted gain to the corresponding signal, list of signals, or media resource.

For example, the current gain of the signal “play” is 200 decibels. If the MGC delivers a gai signal that carries a parameter “si” whose value is “play” and carries a gd parameter whose value is “50 decibels” or “25%”, the MG adjusts the gain of the play signal to 250 decibels. If the MGC delivers a gai signal that carries a parameter “si” whose value is “play” and carries a delta parameter whose value is “−50 decibels” or “−25%”, the MG adjusts the gain of the play signal to 150 decibels. If the MGC delivers a gai signal that carries a parameter “si” whose value is “play” and carries a gd parameter whose value is “0”, the MG lets the gain of the play signal be still 200 decibels. If the MGC delivers a gai signal that carries a parameter “si” whose value is “play” and carries an ag parameter whose value is “100 decibels”, the MG adjusts the gain of the play signal to 100 decibels.

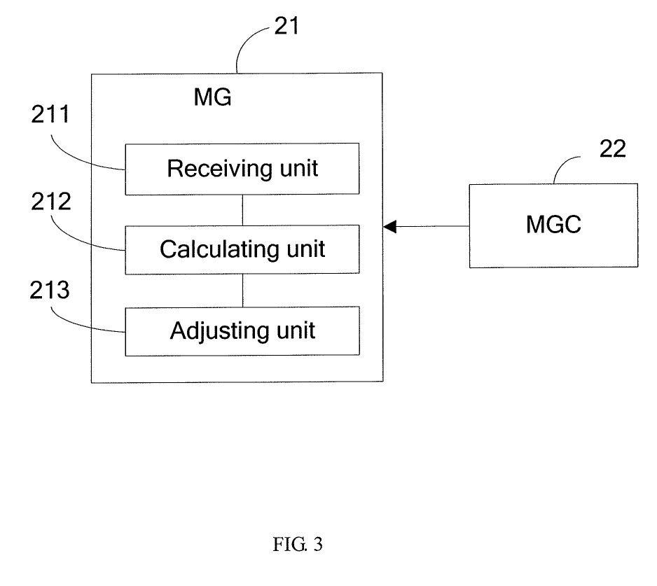

FIG. 3 shows a system structure in an embodiment of the present invention. The system includes an MG 21 and an MGC 22. The MG 21 includes a receiving unit 211, a calculating unit 212, and an adjusting unit 213.

The MGC 22 is configured to send control information to the receiving unit 211 of the MG 21 for adjusting gain of a signal by setting the gain to a specific value directly or by changing the current value with an increment; and the adjusting unit 213 is configured to adjust the gain of the signal according to the control information received by the receiving unit 211.

(1) When the control information is about adjusting gain of the signal by increasing the value of the current gain, the adjustment mode is as follows: The calculating unit 212 calculates the target gain according to the control information and the current gain of the signal; and the adjusting unit 213 adjusts the gain of the signal according to the target gain calculated by the calculating unit 212.

(2) When the control information is about adjusting the gain of the signal by setting the gain to a specific value directly, the adjusting mode is: The adjusting unit 213 adjusts the signal gain to the target gain. In this way, no calculating unit 212 needs to exist in the media gateway 21.

After reading the foregoing embodiments, those skilled in the art are clearly aware that the embodiments of the present invention may be implemented through hardware, or, preferably in most circumstances, through software in addition to a necessary universal hardware platform. Therefore, the technical solution under the present invention or its novelty over the prior art may be embodied in a software product. The software product is stored in a computer-readable storage medium such as computer floppy disk, hard disk and CD-ROM, and incorporates several instructions for instructing a computer device (for example, personal computer, server, or network device) to execute the method specified in any embodiment of the present invention.

The above descriptions are merely preferred embodiments of the present invention, but are not intended to limit the scope of the present invention. Any modifications, variations or replacement that can be easily derived by those skilled in the art without departing from the spirit and scope of the invention shall fall within the protection scope of the present invention.

1. A signal gain control method, comprising:
by a Media Gateway (MG), receiving control information from a Media Gateway Controller (MGC), wherein the control information relates to adjusting gain of a signal by setting the gain to a specific value directly or by changing the current value with an increment; and
adjusting, by the MG, the gain of the signal according to the control information.

2. The method according to claim 1, wherein:
when the control information relates to adjusting gain of the signal by changing the current value with an increment, the control information is a gain delta parameter indicating an increment between a target gain and a current gain of the signal; and
the MG calculates the target gain according to the control information and the current gain of the signal, and then adjusts the gain of the signal to the target gain.

3. The method according to claim 2, wherein:
a positive value of the increment represents decibels or a percentage by which the target gain increases relative to the current gain; and
a negative value of the increment represents decibels or a percentage by which the target gain is lower than the current gain.

4. The method according to claim 3, wherein:
an increment 0 indicates that the target gain is the same as the current gain.

5. The method according to claim 1, wherein:
when the control information relates to adjusting gain of the signal by setting the gain to a specific value directly, the control information is an absolute gain parameter indicating a target gain; and
the MG adjusts the gain of the signal to the target gain.

6. The method according to claim 5, wherein:
the target gain is measured in decibels.

7. The method according to claim 1, wherein:
the MG receives the control information from the MGC in the following way:
the MG receives a first signal that carries the control information from the MGC, wherein the first signal is the signal whose gain needs to be adjusted.

8. The method according to claim 1, wherein:
the MG receives the control information from the MGC in the following way:
the MG receives a second signal that carries the control information from the MGC, wherein the second signal indicates the signal whose gain needs to be adjusted.

9. The method according to claim 8, wherein:
the second signal further includes at least one of: a signal identifier, a signal list identifier and a media resource identifier for indicating the signal that needs to be adjusted.

10. A Media Gateway (MG), comprising:
a receiving unit, configured to receive control information from a Media Gateway Controller (MGC), wherein the control information relates to adjusting gain of a signal by setting the gain to a specific value directly or by changing the current value with an increment; and
an adjusting unit, configured to adjust the gain of the signal according to the control information.

11. The MG according to claim 10, wherein:
when the control information relates to adjusting gain of the signal by increasing the value of the current gain, the MG further comprises:
a calculating unit, configured to calculate a target gain according to the control information and a current gain of the signal; and
the adjusting unit adjusts the gain of the corresponding signal according to the target gain calculated by the calculating unit.

12. A communication system, comprising:
a Media Gateway Controller (MGC), configured to send control information to a Media Gateway (MG) for adjusting gain of a signal by setting the gain to a specific value directly or by changing the current value with an increment; and
the MG, configured to receive the control information and adjust the gain of the signal according to the control information.

13. The system according to claim 12, wherein:
when the control information relates to adjusting gain of the signal by increasing the value of the current gain, the MG is specifically configured to calculate a target gain according to the control information and a current gain of the signal, and adjust the gain of the corresponding signal according to the target gain calculated out.

14. A Media Gateway Controller (MGC), comprising:
a sending module, configured to send control information to a Media Gateway (MG) as an instruction of adjusting gain of a signal by setting the gain to a specific value directly or by changing the current value with an increment.
